(19) United States
(12) Patent Application Publication
(10) Pub. No.: US 2014/0208297 A1
(43) Pub. Date: Jul. 24, 2014

(54) Validation of revised computer programs

(71) Applicant: INTERNATIONAL BUSINESS MACHINES CORPORATION, Armonk, NY (US)

(72) Inventors: Hana Chockler, Haifa (IL); Sitvanit Ruah, Rehovot (IL)

(73) Assignee: International Business Machines Corporation, Armonk, NY (US)

(21) Appl. No.: 13/745,805

(22) Filed: Jan. 20, 2013

(51) Int. Cl. G06F 11/36

(52) U.S. Cl. CPC G06F 11/3608
USPC 717/126

(57) ABSTRACT

A computer implemented method, an computerized apparatus and a computer program product for validating revised computer programs. The method performed by a computerized device, comprising: validating a computer program having one or more revised instructions, wherein said validating comprises: checking the computer program with respect to only a portion of a Control Flow Graph (CFG) of the computer program, wherein the portion of the CFG including all paths of the CFG that include at least one node associated with a revised instruction.

### TECHNICAL FIELD

The present disclosure relates validation of computer programs in general, and to validation of revised computer programs, in particular.

### BACKGROUND

Computerized devices control almost every aspect of our life—from writing documents to controlling traffic lights. A computerized device may be implemented using a computer program. Computerized devices are bug-prone, and thus require a testing phase in which the bugs should be discovered. The testing phase is considered one of the most difficult tasks in designing a computerized device. The cost of not discovering a bug may be enormous, as the consequences of the bug may be disastrous. For example, a bug may cause the injury of a person relying on the designated behavior of the computerized device. Additionally, a bug in hardware or firmware may be expensive to fix, as patching it requires call-back of the computerized device. Hence, many developers of computerized devices invest a substantial portion of the development cycle to discover erroneous behaviors of the computerized device.

During testing phase, developers, QA staff members, and the like test computer programs to verify that a newly developed computer program operates properly.

In some cases, computer programs may be subject to changes. Changes in computer programs can be made for several reasons such as: maintenance (e.g. fixing errors and flaws, adding compatibility to hardware changes, and the like) and enhancements (e.g. adding new functionality, improving efficiency and the like).

Changes made in a computer program may introduce bugs that were not present before the computer program was changed. Changes made in a computer program may also expose bugs that were present before the computer program was changed, but did not get exercised.

Therefore making changes in a computer program may require a testing phase of the revised computer program. Testing a revised computer program may be a heavy resource consuming process and in some cases due to its resource consuming nature, may be infeasible or ineffective.

### BRIEF SUMMARY

One exemplary embodiment of the disclosed subject matter is a computer-implemented method performed by a computerized device, comprising: validating a computer program having one or more revised instructions, wherein the validating comprises: checking the computer program with respect to only a portion of a Control Flow Graph (CFG) of the computer program, wherein the portion of the CFG including all paths of the CFG that include at least one node associated with a revised instruction.

Another exemplary embodiment of the disclosed subject matter is a computerized apparatus having a processor, the processor being adapted to perform the steps of: validating a computer program having one or more revised instructions, wherein the validating comprises: checking the computer program with respect to only a portion of a Control Flow Graph (CFG) of the computer program, wherein the portion of the CFG including all paths of the CFG that include at least one node associated with a revised instruction.

Yet another exemplary embodiment of the disclosed subject matter is a computer program product comprising a non-transitory computer readable medium retaining program instructions, which instructions when read by a processor, cause the processor to perform a method comprising: validating a computer program having one or more revised instructions, wherein the validating comprises: checking the computer program with respect to only a portion of a Control Flow Graph (CFG) of the computer program, wherein the portion of the CFG including all paths of the CFG that include at least one node associated with a revised instruction.

### THE BRIEF DESCRIPTION OF THE SEVERAL VIEWS OF THE DRAWINGS

The present disclosed subject matter will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIGS. 1A-1C show flowchart diagrams of steps in methods, in accordance with some exemplary embodiments of the disclosed subject matter;

FIGS. 2A-2C show illustrations of a Control Flow Graph (CFG); and

FIG. 3 shows an apparatus in accordance with some exemplary embodiments of the disclosed subject matter.

### DETAILED DESCRIPTION

The disclosed subject matter is described below with reference to flowchart illustrations and/or block diagrams of methods, apparatus (systems) and computer program products according to embodiments of the subject matter. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

In the present disclosure, the term “concolic” should be understood as referring to a combination of both a concrete state and a symbolic state. Concolic tools may include, for example, a concolic execution tool, such as described in Patrice Godefroid, Nils Klarlund, Koushik Sen: DART: directed automated random testing. PLDI 2005: 213-223, which is hereby incorporated by reference in its entirety. Additionally or alternatively, concolic tools may comprise a concolic model checker, such as described in Sharon Barner, Cindy Eisner, Ziv Glazberg, Daniel Kroening, Ishai Rabinovitz: ExpliSAT: Guiding SAT-Based Software Verification with Explicit States. Haifa Verification Conference 2006: 138-154, which is hereby incorporated by reference in its entirety.

One technical problem dealt with by the disclosed subject matter is to validate a revised computer program. Validation may be performed using formal verification methods, such as model checking. Additionally or alternatively, validation may be performed using testing methods, such as execution, symbolic execution and concolic execution, or the like. In some exemplary embodiments, computer program revision may be performed by adding deleting or changing one or more computer program instructions. Revision of a computer program may introduce computer program errors to the revised computer program. The revision may reveal latent computer program errors not directly associated with revised instructions. Therefore, when the computer program is revised, there may be a need to validate the entire computer program with no relation to the type of revision or its scope. Computer program verification is a high resource consuming process, and as such, in some cases, it may be infeasible.

Another technical problem dealt with by the disclosed subject matter is validating only the revised portion of a computer program. In some exemplary embodiments, the revised portion of the computer program may be the set of all revised instructions. Alternatively or additionally, the revised portion may be one or more instructions that may execute differently in view of the revision. As an example, the revised instruction may modify a value of a variable of the computer program. The modified value may cause another, non-revised instruction, to perform an erroneous functionality.

In some exemplary embodiments, validating only a portion of the computer program may reduce the amount of resources used by the validation process, such as formal verification. In some exemplary embodiments, in case the original non-revised computer program was functioning properly, validating the portion of the computer program may be sufficient to ensure that the revised computer program functions properly.

Yet another technical problem dealt with the disclosed subject matter is to validate a portion of a computer program without having available information associated with a validation of a previous version of the computer program. In some exemplary embodiments, the computer program may have never been validated before.

One technical solution provided by the disclosed subject matter is performing validation of the revised computer program with respect to only a portion of a control Flow Graph (CFG) of the computer program.

In some exemplary embodiments, the CFG may be an abstract representation of a computer program. In some exemplary embodiments, the CFG may be a directed graph comprising nodes and edges. Each node of the CFG may be associated with an instruction of the computer program. The edges of the CFG may indicate a potential control flow change from a first node to a second node, so that a second instruction associated with the second node is executed after executing a first instruction which is associated with the first node. In some exemplary embodiments, the CFG may indicate one or more initial nodes from which the execution of the computer program commences.

In some exemplary embodiments, a path of a CFG, also referred to as an execution path, may be a set of nodes that are connected to one another by edges of the CFG. The path may start from one of the initial node of the CFG. In some exemplary embodiments, each execution of a computer program may be said to follow a certain execution path of the CFG.

The portion of the CFG associated with the revised computer program, may refer to a portion of the computer program that comprises all instructions that the revision has the potential of changing their functionality. It will be noted that the change in functionality may be manifested in a variety of manners. As non-limiting examples only, consider the following examples: (1) an instruction that was not executed in the non-revised computer program will be executed; (2) an instruction that was executed in the non-revised computer program will not be executed; (3) an executed instruction will have a different effect in the revised computer program in comparison to the effect in the non-revised computer program.

In some exemplary embodiments, the portion of the CFG may include all paths that, when executed, will execute at least one revised instructions of the revised computer program. In some exemplary embodiments, each such path may include at least one node associated with a revised instruction.

In some exemplary embodiments, the revised computer program may be validated by performing model checking of the computer program with respect to only the portion of the CFG thereby verifying the functionality that is potentially affected by the revision of the computer program. Additionally or alternatively, validation may be performed using execution methods, such as concolic or symbolic execution, which may be configured to only follow the portion of the CFG. In some exemplary embodiments, in response to a successful validation of the revised computer program with respect to the portion of the CFG, the computer program may be validated with respect to the remainder of the CFG. Alternatively or additionally, the remainder may be checked even in case that an error was detected with respect to the portion of the CFG.

Another technical solution provided by the disclosed subject matter is to identify the portion of the CFG. In some exemplary embodiments, the CFG may be traversed to detect all nodes and edges that are associated with the portion of the CFG. In some exemplary embodiments, the CFG may be traversed, in a forward direction and in a backward direction, from each node that is associated with a revised instruction. In some exemplary embodiments, during such traversal the portion of the CFG may be marked. Additionally or alternatively, during such traversal, each traversed edge may be given higher priority than non-traversed edge, thereby enabling priority-based traversal of the CFG that is configured to start by traversing the portion of the CFG and continue with traversing the reminder of the CFG.

Yet another technical solution provided by the disclosed subject is to identify CFG paths by identifying sub paths in the CFG and conjuncting the sub paths to determine the paths. In some exemplary embodiments, a backward traversal may be performed from one or more nodes of the CFG to identify a first group of sub paths. Alternatively or additionally, a forward traversal may be performed from the one or more CFG nodes to identify a second group of sub paths. In some exemplary embodiments, based on the sub-paths, a set of paths that collectively define the portion of the CFG, may be identified. A path may be identified by conjuncting two sub-paths which share a common node, so that traversal of the path start in a first sub-path and ends in a second sub-path. In some exemplary embodiments, the first sub-path may be identified during the backward traversal while the second sub-path may be identified during the forward traversal.

Yet another technical solution provided by the disclosed subject is to identify the portion of the CFG when the revision of the computer program comprises more than one revised computer program instruction. In some exemplary embodiments, the portion of the CFG may be determined by traversing for each node associated with a revised computer instruction, also referred to as a revised node, both in a forward direction and in a backward direction.

In some exemplary embodiments, duplicative information may be avoided by determining a first subset of the revised nodes for forward traversal purposes and determining a second subset of the revised nodes for backward traversal purposes. In some exemplary embodiments, the first subset of the revised nodes may be determined based on cone of influence analysis of the CFG. Additionally or alternatively, the second subset of the revised nodes may be determined based on a reversed cone of influence analysis of the CFG.

Cone of influence analysis may refer to analyzing which nodes are reachable from a node in accordance with the CFG and the direction of the edges as defined by the CFG. Reversed cone of influence analysis may refer to analyzing from which nodes the node is reachable. In some exemplary embodiments, reversed cone of influence may be implemented by performing a cone of influence analysis on an inverse version of the CFG (i.e., the same nodes with edges having a reverse direction).

One technical effect of utilizing the disclosed subject matter relates to reducing the amount of resources used in the validation process.

Another technical effect of utilizing the disclosed subject matter relates to enabling validation of just the revised portion of the computer program without relying on information regarding validation of a previous version of the computer program.

Yet another technical effect of utilizing the disclosed subject matter relates to improving the scalability of a validation tool, such as for example a model checker, a formal verification tool, a symbolic execution tool, a concolic execution tool, or the like, when validating a computer program, such as by enabling iterative validation of the computer program, one revision after another.

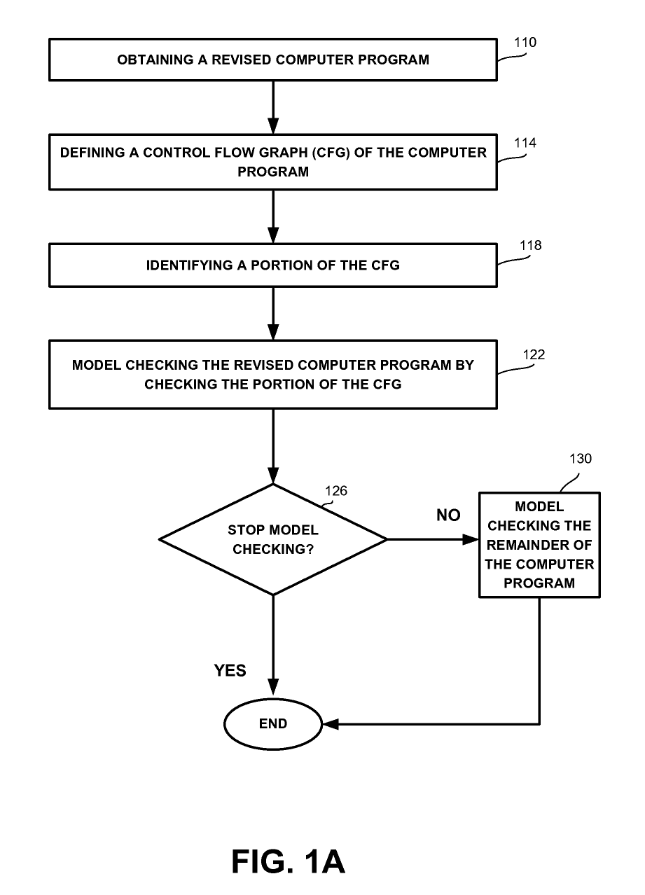

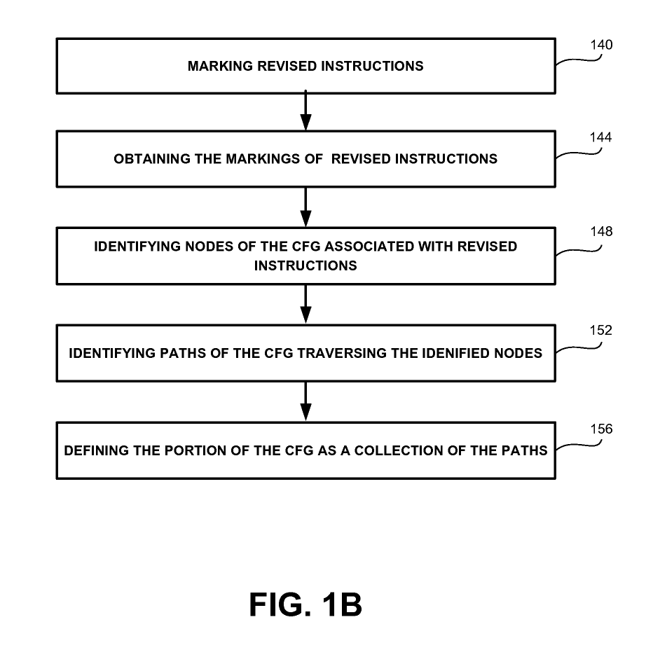

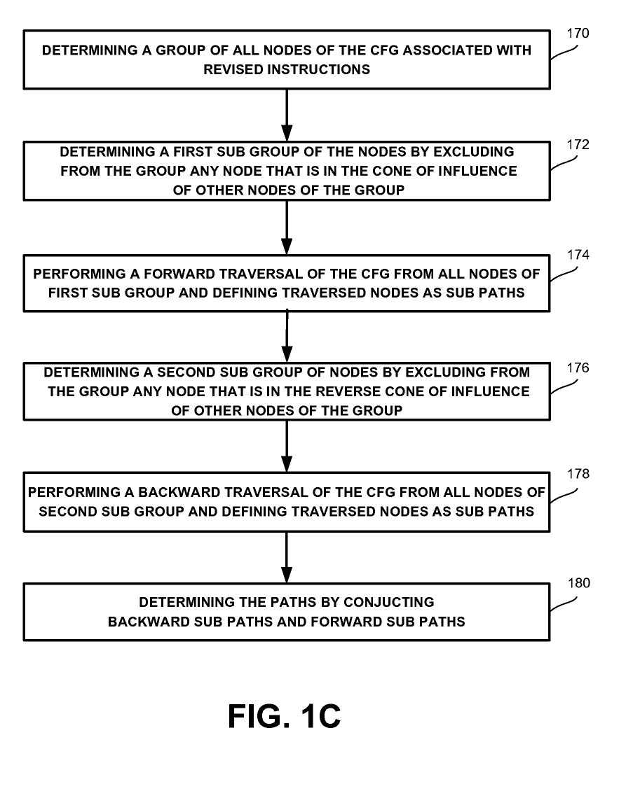

Referring now to FIG. 1A showing a flowchart diagram of a method, in accordance with some exemplary embodiments of the disclosed subject matter.

In Step 110, a revised computer program may be obtained. In some exemplary embodiments, the revision of the computer program may add, delete or change one or more computer program instructions. In some exemplary embodiments, the revised computer program may be a previously validated computer program. Additionally or alternatively, the revised computer program may be a computer program that was not previously validated.

In Step 114, a Control Flow Graph (CFG) may be defined. The CFG may be automatically determined based on the instructions of the revised computer program.

In Step 118, a portion of the CFG may be identified. The portion of a CFG may comprise a subset of all paths of the CFG. In some exemplary embodiments, the portion of the CFG is identified as demonstrated in FIG. 1B. In some exemplary embodiments, the portion of the CFG is a portion of the revised program, which if executed, may be affected by the revision. For example, the portion may comprise each path which, if executed has the potential to provide a different functionality than in the non-revised version of the computer program. In some exemplary embodiments, the portion may be defined by excluding from the CFG any path which, if executed, would not have been affected by the revision.

In Step 122, the computer program may be partially validated by validation the computer program with respect to the portion of the CFG. In some exemplary embodiments, the validation may include executing, simulating execution, or the like, of any path in the portion of the CFG. In some exemplary embodiments, the validation may be performed by a validation tool, such as but not limited to a model checker that is configured to check that a model of the revised computer program holds a specification indicating of no errors, a concolic execution tool which is configured to execute, using both a concrete state and a symbolic state, the revised computer program in order to identify bugs and errors. Other validation tools may also be applicable to the disclosed subject matter.

In response to validation of the portion of the CFG in Step 122, Step 126 may be performed. Step 126 may determine whether or not to validate a reminder of the CFG. The validation of the remainder of the computer program may be performed manually, automatically, or semi-automatically based on rules, commands or parameters, such as for example in response to detecting a bug with respect to a portion avoid validation with respect to the remainder, or in response to successfully validating the computer program with respect to the portion of the CFG, continuing to validate the computer program with respect to the remainder. In some exemplary embodiments, a user may determine if the computer program will be validated with respect to the remainder of the CFG. The determination may be inputted by a user. Additionally or alternatively, the validation of the remainder of the computer program may depended on the determination that the portion has no errors in it.

In Step 130, the revised computer program may be validated with respect to the remainder of the CFG. In some exemplary embodiments, validating the remainder of the CFG may be useful in detecting bugs and errors which were not introduced by the revision of the computer program.

Referring now to FIG. 1B showing a flowchart diagram of a method in accordance with some exemplary embodiments of the disclosed subject matter. In some exemplary embodiments, Step 118 of FIG. 1A may be implemented by the steps described in FIG. 1B.

In Step 140, a revised computer program may be obtained. In some exemplary embodiments the revision may be performed by a user, such as a developer, adding deleting or changing one or more computer program instructions. Indications identifying the revised computer instructions may be defined by the user, by an automatic or semi-automatic tool, or the like. In some exemplary embodiments the revised instructions may be marked by adding labels indicating a revised instruction in the computer program. In some exemplary embodiments, a deleted instruction may be indicated by adding a null instruction, such as an empty line, an assigning a label thereto. Alternatively or additionally, other means may be used to mark the revised instructions. Alternatively or additionally, a file containing a list of the revised instructions may be used to indicate the revised instructions.

In Step 144, the markings of the revised instructions may be obtained. The markings may be obtained from a user, from an electronic media, or the like.

In Step 148, nodes of the CFG that are associated with revised instructions may be identified. In some exemplary embodiments, the nodes may be identified using the marking obtained In Step 144.

In Step 152, paths of the CFG, that include at least one of the nodes identified in Step 148 may be identified. In some exemplary embodiments, the paths may be identified by traversing the CFG, by brute force enumeration of the paths, or the like. In some exemplary embodiments, the paths may be identified using forward and backward traversal as demonstrated in FIG. 1C.

In some exemplary embodiments, forward traversal of the CFG may be performed from the nodes of Step 148. Backward traversal of the CFG may be performed from the nodes of Step 148. Any combination of traversed nodes of the CFG may be considered as a path that includes at least one of the nodes of Step 148.

In Step 156, the portion of the CFG may be defined as a collection of the paths identified in Step 152.

Referring now to FIG. 1C showing a flowchart diagram of a method in accordance with some exemplary embodiments of the disclosed subject matter In some exemplary embodiments, Step 152 of FIG. 1B may be implemented by the steps described in FIG. 1C.

In Step 170, a group of all CFG nodes associated with revised instructions may be identified. In some exemplary embodiments, the nodes associated with revised instructions may be identified as demonstrated In Step 148.

In Step 172, a first sub group of the nodes may be defined by excluding from the group of nodes any node that is in the cone of influence of other nodes of the group. The cone of influence of a node may comprises all nodes that may be traversed when a forward traversal is performed from the node.

In Step 174, a forward traversal of the CFG may be performed from all nodes of the first sub group. In some exemplary embodiments, the traversed nodes may be marked. In some exemplary embodiments, a first collection of sub-paths may be defined based on the traversed nodes. Additionally or alternatively, the marking of the paths may be used to define the sub paths.

In Step 176, a second sub group of nodes may be defined by excluding from the group of nodes any nod that is in the reverse cone of influence of other nodes of the group. The reverse cone of influence of a node comprises all predecessor nodes of the node.

In Step 178, a backward traversal of the CFG may be performed from all nodes of the second sub group. In some exemplary embodiments, the traversed nodes may be marked. In some exemplary embodiments, a second collection of sub-paths may be defined based on the traversed nodes. Additionally or alternatively, the marking of the paths may be used to define the sub paths.

In Step 180, sub-paths from both the first and second collections may be conjuncted to produce paths. The conjunction of the sub paths may be performed with respect to overlapping segments of the conjuncted sub paths. The portion of the CFG may be defined as the collection of all conjuncted paths.

In some exemplary embodiments, priorities may be assigned to edges during traversal of the CFG, whether forward or backward. The priorities may guide the validation procedure to give precedent to validating the portion of the CFG over validating the remainder of the CFG. In some exemplary embodiments, a tool such as a concolic execution tool, a concolic model checker, or the like, may be guided by the priorities assigned to the edges of the CFG.

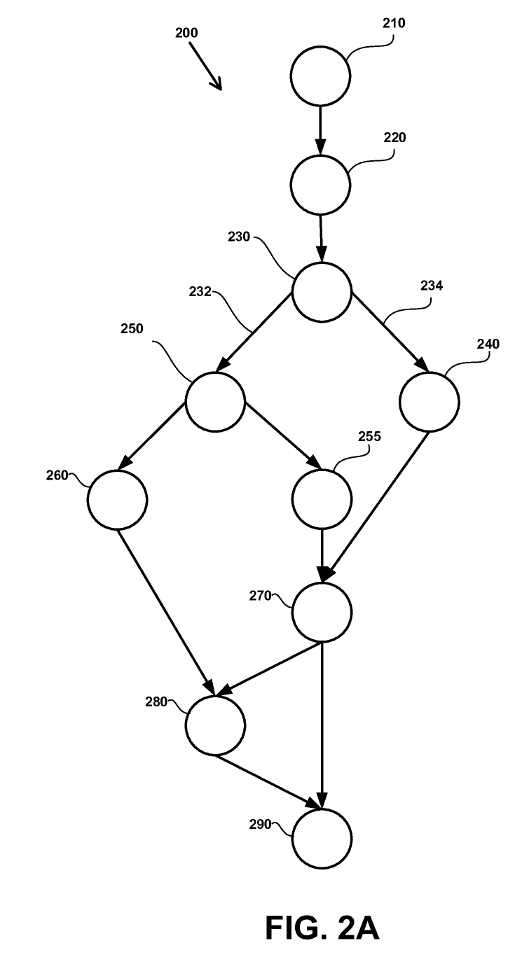

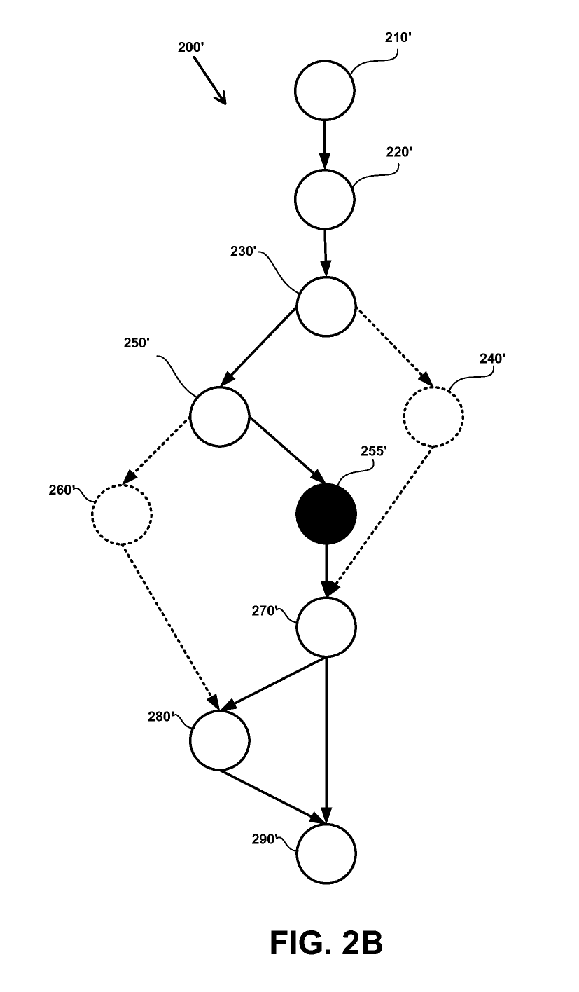

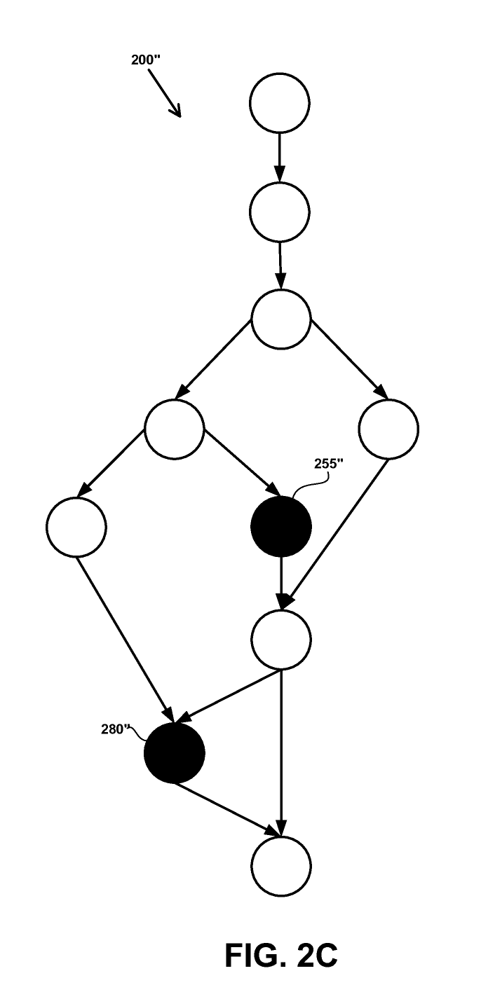

Referring now to FIG. 2A showing a CFG 200, in accordance with some exemplary embodiments of the disclosed subject matter. CFG 200 comprises nodes, such as 210, 220 and edges having a direction, such as 232, 234. Nodes of CFG 200 are connected by edges; for example an Edge 232 connects Node 230 and Node 250. A direction of an edge indicates a flow direction of the CFG. If from a single node there are two outgoing edges, then it is possible that after executing the instruction associated with the node, either instructions of the connected edges may be performed. For Example, an instruction associated with Node 250 may be followed by executing either the instruction associated with Node 255 or with Node 260.

An initial node of CFG 200 may be a node, which has no incoming edges, such as Node 210.

CFG 200 depicts five alternative execution paths: A first path including: Node 210, Node 220, Node 230, Node 250, Node 260, Node 280, Node 290; a second path including Node 210, Node 220, Node 230, Node 250, Node 255, Node 270, Node 280, Node 290; a third path including Node 210, Node 220, Node 230, Node 250, Node 255, Node 270, Node 290; a fourth path including Node 210, Node 220, Node 230, Node 240, Node 270, Node 280, Node 290; and a fifth path including Node 210, Node 220, Node 230, Node 240, Node 270, Node 290.

Referring now to FIG. 2B showing a portion of CFG 200′, in accordance with some exemplary embodiments of the disclosed subject matter. Assuming Node 255′ is the only node which is associated with a revised instruction, the portion of CFG 200′ may include 2 executions paths and exclude 3 execution paths of CFG 200′.

In some exemplary embodiments, the portion may be identified by performing a forward traversal from Node 255′, thereby traversing Nodes 270′, 280′ and 290′ and by performing backward traversal from Node 255′, thereby traversing Nodes 250′, 230′, 220′, 210′. As can be appreciated, Nodes 240′ and 260′ are not traversed and thereby may not be included in the portion of CFG 200′. Accordingly, outgoing and incoming edges from such nodes may also be excluded from the portion of CFG 200′. FIG. 2B illustrates the exclusion using discontinuous lines.

Referring now to FIG. 2C showing a CFG having a plurality of revised nodes, in accordance with some exemplary embodiments of the disclosed subject matter. In FIG. 2C, both Node 255″ and 280″ of CFG 200″ are associated with revised computer instructions.

As can be appreciated, Node 280″ is in the cone of influence of node 255″. Therefore, forward traversal may be performed only from Node 255″ as forward traversal from Node 280″ may provide duplicative and redundant information. Similarly, Node 255″ is in the reverse cone of influence of Node 280″ and therefore backward traversal may be performed from Node 280″.

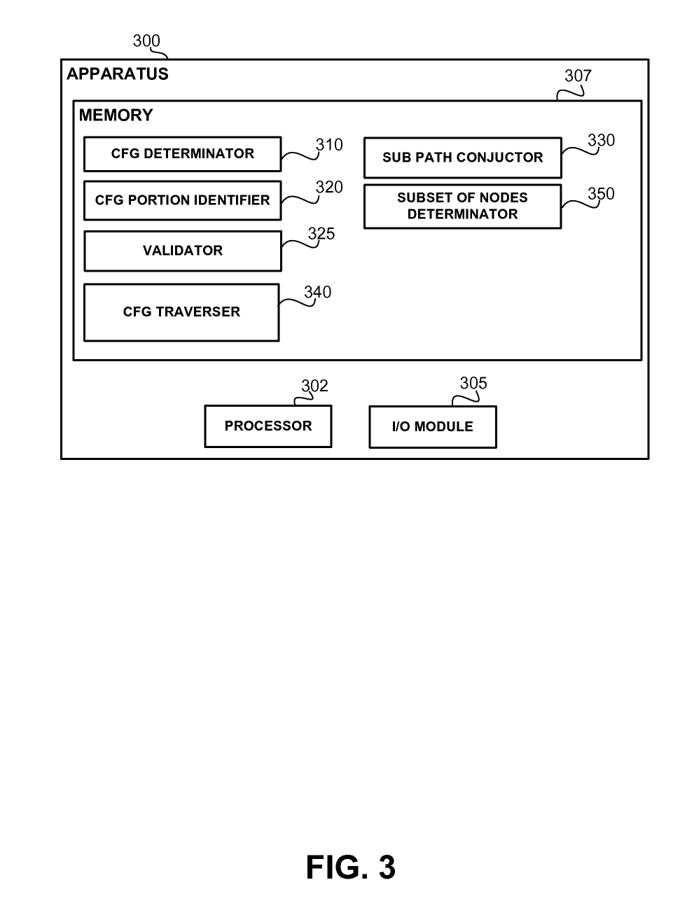

Referring now to FIG. 3 showing an apparatus in accordance with some exemplary embodiments of the disclosed subject matter. An Apparatus 300 may be configured to perform validation of a portion of the functionality of a computer program, in accordance with the disclosed subject matter.

In some exemplary embodiments, Apparatus 300 may comprise a Processor 302. Processor 302 may be a Central Processing Unit (CPU), a microprocessor, an electronic circuit, an Integrated Circuit (IC) or the like. Processor 302 may be utilized to perform computations required by Apparatus 300 or any of it subcomponents.

In some exemplary embodiments of the disclosed subject matter, Apparatus 300 may comprise an Input/Output (I/O) Module 305. I/O Module 305 may be utilized to provide an output to and receive input from a user. In some exemplary embodiments, I/O Module 305 may be utilized to provide an interface to a user (not shown), which may utilize a Man-Machine Interface (MMI) (not shown), to interact with Apparatus 300, such as by reviewing results, logs and the like, providing commands, rules, preferences, formulas or the like, or interacting in any similar manner.

In some exemplary embodiments, Apparatus 300 may comprise a Memory Unit 307. Memory Unit 307 may be persistent or volatile. For example, Memory Unit 307 can be a Flash disk, a Random Access Memory (RAM), a memory chip, an optical storage device such as a CD, a DVD, or a laser disk; a magnetic storage device such as a tape, a hard disk, storage area network (SAN), a network attached storage (NAS), or others; a semiconductor storage device such as Flash device, memory stick, or the like. In some exemplary embodiments, Memory Unit 307 may retain program code operative to cause Processor 302 to perform acts associated with any of the steps shown in FIGS. 1A-1C.

The components detailed below may be implemented as one or more sets of interrelated computer instructions, executed for example by Processor 302 or by another processor. The components may be arranged as one or more executable files, dynamic libraries, static libraries, methods, functions, services, or the like, programmed in any programming language and under any computing environment.

A CFG Determinator 310 may be configured to determine a CFG of a computer program. In some exemplary embodiments, CFG Determinator 310 may perform Step 114 of FIG. 1A.

A CFG Portion Identifier 320 may be configured to identify a portion of the CFG. The portion of the CFG may be a portion which is affected by a revision introduced in the revised computer program. In some exemplary embodiments, CFG Portion Identifier 320 may perform Step 118 of FIG. 1A.

In some exemplary embodiments, CFG Portion Identifier 320 may utilize CFG Traverser 340 to traverse the CFG, in a backward and/or forward direction to identify the portion. In some exemplary embodiments, CFG Traverser 340 may be configured to traverse the CFG from a node that is associated with a revised instruction.

A Validator 325 may be configured to validate the computer program. In some exemplary embodiments, Validator 325 may be a model checker, such as an explicit model checker, a BDD-based model checker, a SAT-based model checker, a concolic model checker, a combination thereof, or the like. In some exemplary embodiments, Validator 325 may be a testing tool, an execution tool, or the like.

A CFG Traverser 340 may be configured to traverse the CFG. In some exemplary embodiments, the CFG Traverser 340 may traverse the CFG in a backward direction and/or in a forward direction. Additionally or alternatively, the CFG traversal may be performed from any node of the CFG. In some exemplary embodiments, the traversed nodes may be marked. Additionally or alternatively, traversed edges may be marked or given priorities by the CFG Traverser 340. In some exemplary embodiments, a collection of sub-paths may be defined based on the traversed nodes. Additionally or alternatively, the marking of the paths may be used to define sub paths. In some exemplary embodiments, the CFG Traverser 340 may be configured to perform Step 152 of FIG. 1B, Steps 174, 178 of FIG. 1C, or the like.

A Sub-Path Conjunctor 330 may be configured to conjunct sub-paths of the CFG. In some exemplary embodiments, the conjunction of sub-paths may be performed with respect to overlapping segments of the conjuncted sub-paths. In some exemplary embodiments, Sub-Path Conjunctor 330 may be utilized by CFG Portion Identifier 320. The conjuncted sub-paths may produce the set of paths which are comprised by the portion of the CFG. In some exemplary embodiments, Sub-Path Conjunctor 330 may be configured to perform Step 152 of FIG. 1B and Step 180 of FIG. 1C, or the like.

A Subset of Nodes Determinator 350 may be configured to determinate subset of nodes to be utilized in identifying the portion of the CFG. Subset of Nodes Determinator 350 may be configured to obtain a set of nodes which are associated with revised instructions and determine a subset thereof. In some exemplary embodiments, the subset may be obtained by excluding from the set any node which is in the cone of influence of another node of the set. Additionally or alternatively, the subset may be obtained by excluding from the set any node which is in the reverse cone of influence of another node of the set. In some exemplary embodiments, Subset of Nodes Determinator 350 may be utilized to perform Steps 170, 172, 176 of FIG. 1C, Step 148 of FIG. 1B, or the like.

### Embodiment

Some exemplary embodiments of the disclosed subject matter may implement the following pseudo-code:

Function FINDROOTTOUPDATENODES
Input : Node u, CFG G
Output: Set nodes_from_root

append u to bfs_queue
nodes_from_root ← u
while bfs_queue ≠ φ do

q ← FrontOf(bfs_queue)
for each incoming edge e = (v, q) do

if e is not repeating then

if v ∉ nodes_from_root then

nodes_from_root ← v
bfs_queue ← v

remove q from bfs_queue

return nodes_from_root

Function FINDUPDATECONE
Input : Node u, CFG G
Output: Set update_cone_nodes

bfs_queue ← φ
append u to bfs_queue
insert u to update _cone_nodes
while bfs_queue is not empty do

q ← FrontOf(bfs_queue )
for each outgoing edge e = (q, v) do

if e is not a loop-back edge then

if v ∉ update_cone_nodes then

insert v to update_cone_nodes
append v to bfs_queue

remove q from bfs_queue

return update_cone_nodes

procedure FINDUPDATEPATHNODES
Input: program P, Node u
Output: Sets nodes_from_root, update_cone_nodes

construct the CFG G reachable from the first statement
nodes_from_root ← FINDROOTTOUPDATENODES(u, G)
update_cone_nodes ← FINDUPDATECONE(u, G)

Procedure ModelChecking(program P, Node u)

FINDUPDATEPATHNODES(P,u)
root_to_update_stats ← initial state
while some state queue is non empty do

s ← FrontOf(highest priority state queue)
Generate successors of s
for each successor t of s do

if t is a new state then

validate_state(t)
if t.node ∈ nodes_from_root then

root_to_update_states ← t

else if t.node ∈ update_cone_nodes then

update_cone_states ← t

else

low_priority_states ← t

delete s from its queue

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of program code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As will be appreciated by one skilled in the art, the disclosed subject matter may be embodied as a system, method or computer program product. Accordingly, the disclosed subject matter may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer-usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, and the like.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A computer-implemented method performed by a computerized device, comprising:
validating a computer program having one or more revised instructions, wherein said validating comprises: checking the computer program with respect to only a portion of a Control Flow Graph (CFG) of the computer program, wherein the portion of the CFG including all paths of the CFG that include at least one node associated with a revised instruction.

2. The computer-implemented method of claim 1, further comprising: in response to said checking only the portion, checking the computer program with respect to a reminder of the CFG.

3. The computer-implemented method of claim 2, wherein said checking the computer program with respect to the reminder of the CFG is performed in response to a determination that no error in the computer program was detected in said checking the computer program with respect to only the portion of the CFG.

4. The computer-implemented method of claim 1, wherein said validating is performed without having available information regarding a validation process of a version of the computer program excluding the one or more revised instructions.

5. The computer-implemented method of claim 1, wherein a revised instruction of the one or more revised instructions is selected from group consisting of:
adding one or more instructions to the computer program;
changing one or more instructions in the computer program; and
removing one or more instructions from the computer program.

6. The computer-implemented method of claim 1 further comprises obtaining a marked version of the computer program, wherein the marked version indicates the one or more revised instructions.

7. The computer-implemented method of claim 1, wherein said validation is performed by a validation tool utilizing a symbolic representation of information associated with the computer program.

8. The computer-implemented method of claim 7, wherein the information associated with the computer program is a heap and stack content of the computer program excluding control flow information.

9. The computer-implemented method of claim 7, wherein the validation tool is selected from a group consisting of:
a concolic model checker; and
a concolic execution tool.

10. The computer-implemented method of claim 1, wherein said validating comprises identifying the portion of the CFG, wherein said identifying comprises:
performing a backward traversal of the CFG from at least one node associated with a revised instruction; and
performing a forward traversal of the CFG from the at least one node associated.

11. The computer-implemented method of claim 10,
wherein during said backward traversal and said forward traversal, any edge of the CFG that is traversed is assigned a priority; and
wherein said validating is performed by traversing the CFG in accordance with priorities of edges of CFG.

12. The computerized-implemented method of claim 10,
wherein said forward traversal is performed from a first group of nodes of the CFG; and
said backward traversal is performed from a second group of nodes of the CFG.

13. The computerized-implemented method of claim 12,
wherein said first group is characterized by including nodes that are associated with a first portion of the one or more revised instructions, and no node of the first group is a successor of other nodes of the first group; and
wherein the second group is characterized by including nodes that are associated with a second portion of the one or more revised instructions, and no node of the second group is a predecessor of other nods of the second group.

14. A computerized apparatus having a processor, the processor being adapted to perform the steps of:
validating a computer program having one or more revised instructions, wherein said validating comprises: checking the computer program with respect to only a portion of a Control Flow Graph (CFG) of the computer program, wherein the portion of the CFG including all paths of the CFG that include at least one node associated with a revised instruction.

15. The computerized apparatus of claim 14, wherein said validating is performed by a validation tool utilizing a symbolic representation of information associated with the computer program.

16. The computerized apparatus of claim 15, wherein said validation tool is a concolic validation tool.

17. The computerized apparatus of claim 14, wherein said validating comprises identifying the portion of the CFG, wherein said identifying comprises:
performing a backward traversal of the CFG from at least one node associated with a revised instruction; and
performing a forward traversal of the CFG from the at least one node associated.

18. The computerized apparatus of claim 17,
wherein said backward traversal and said forward traversal are configured to assign priorities to traversed edges of the CFG; and
wherein said validating is performed by traversing the CFG in accordance with priorities of edges of CFG.

19. The computerized apparatus of claim 17,
wherein said forward traversal is performed from a first group of nodes of the CFG, wherein said first group is characterized by including nodes that are associated with a first portion of the one or more revised instructions, and no node of the first group is a successor of other nodes of the first group; and
wherein said backward traversal is performed from a second group of nodes of the CFG, wherein the second group is characterized by including nodes that are associated with a second portion of the one or more revised instructions, and no node of the second group is a predecessor of other nods of the second group.

20. A computer program product comprising a non-transitory computer readable medium retaining program instructions, which instructions when read by a processor, cause the processor to perform a method comprising:
validating a computer program having one or more revised instructions, wherein said validating comprises: checking the computer program with respect to only a portion of a Control Flow Graph (CFG) of the computer program, wherein the portion of the CFG including all paths of the CFG that include at least one node associated with a revised instruction.
